(19) United States
(12) Patent Application Publication
(10) Pub. No.: US 2017/0102279 A1
(43) Pub. Date: Apr. 13, 2017

(54) Torque Sensor Assembly for an Engine Comprising a Central Disc and an Outer Rim

(71) Applicant: Methode Electronics Malta Ltd., Mriehel (MT)

(72) Inventor: Johannes Gießibl, Amerang (DE)

(21) Appl. No.: 15/285,735

(22) Filed: Oct. 5, 2016

(30) Foreign Application Priority Data
Oct. 9, 2015 (DE) DE102015117298.4

(51) Int. Cl. G01L 3/10

(52) U.S. Cl. CPC G01L 3/104

(57) ABSTRACT

A torque sensor assembly an engine comprising: a transducer (1100) including: a central disc (1110); and an outer rim (1160) coupled to the central disc (1110); and at least one sensing element (1210) spaced from the transducer (1100) and configured to determine an amount of torque exerted on the central disc (1110) by sensing a magnetic flux passing through the central disc (1110). There is also a housing (1200) which comprises the sensing element (1210). The central disc (1110) and the outer rim (1160) are assembled in a way that magneto-related stress to the central disc (1110) is avoided.

### RELATED APPLICATION DATA

This application claims the benefit of German patent application ser. no. DE 10 2015 117 298.4, filed Oct. 9, 2015, the disclosure of which is incorporated by reference herein.

### DESCRIPTION

The present invention relates to a torque sensor as well as to torque sensor system which measure a torque generated by an engine whereby the engine could be powered by any type of energy.

The invention also relates to a drive train to be coupled to an engine for transmitting the generated torque. It also relates to methods and sensing devices for power transmissions. More particularly it relates to non-contacting magnetoelastic torque sensors for providing a measure of the torque transmitted radially in a transmission drive plate or similar disc-shaped member. Further, the invention relates to method of measuring torque in a drive train which is arranged between an engine and a gear box. The invention further relates to a method of manufacturing the sensing device.

It is known in the prior art that an optimal gear shift point of a transmission varies with varying total torque generated by an engine.

From the state of the art according to U.S. Pat. No. 9,146,167 B2 it is known to provide an automatic transmission of a vehicle including an input shaft and an output shaft. The input shaft receives an input torque from a power source. Such a power source could be according to this document an internal combustion engine or an electric motor. The transmission then converts the input torque to an output torque whereas the output shaft transmits the output torque to the wheels of the vehicle in order to propel the vehicle. The transmission typically converts the input torque to the output torque by adjusting a gear ratio between the input shaft and the output shaft. According to this document the sensor is coupled to the oil seal housing and the oil seal housing to the engine. Each of the sensor and the oil seal housing has a mounting hole formed therein. It is also mentioned that the sensor is coupled to the oil seal housing and the oil seal housing to the engine, by inserting one fastener into the mounting holes of both components. The document additionally discloses that the sensor is configured to measure an amount of torque exerted on a drive plate of the transmission. The drive plate includes a central disc, made of magnetizable material, and an outer rim coupled to the central disc. The central disc and the outer disc are assembled to each other by press-fitting.

The US 2013/0091960 A1 teaches a magnetic torque sensor for a transmission converter drive plate. A magnetic torque sensing device includes a generally disk-shaped member having opposite circular surfaces and a central axis of rotation. When torque is applied to a disk, magnetic moments in a magnetoelastically active region tilt along the shear stress direction. The tilt causes the magnetization of the magnetoelastically active region to exhibit a decreased component in the initial direction and an increased component in the shear stress direction.

The magnetic torque sensor for a transmission converter drive plate provides a hub that rigidly attaches the disk to a shaft. To permit the disk and the shaft to act as a mechanical unit such that torque applied to the hub is transmitted to the disk, fastening means are provided, comprising pins, splines, keys, welds adhesives, press-fits-combinations or shrink-fit-combinations or the like.

The DE 10 2015 203 279 A1 reveals a torque sensor assembly for a motor vehicle and a method for measuring torque. The document shows a magnetized portion and a ring portion of a drive plate which are connected to each other by press-fitting. The magnetized portion and the ring portion are each provided with mating surfaces that are designed to allow a cylindrical surface-to-surface contact at a desired stress level required for press-fitting.

This entire configuration is, however, complicated in its construction, expensive and in its application not reliable. For the disclosed assembling of the central disc and the outer disc by press-fitting influences the magnetization condition. The press-fitting leads to a stress of the magnetization and magnetic fields in respect of both of the discs. For in most cases of production tolerances of manufacturing have to be taken into account with the consequence that the press-fitting normally requires the use of considerable forces to get both of the parts fitted together.

A consequence of this will be that the method of measuring of torque is no longer reliable to an extent required. The press-fitting of the parts leads to stress within the parts which again causes an influence on the magnetic field.

Therefore, it is one object of the invention to provide a torque sensing device which is generally applicable to the measurement of torque in any plate-shaped member that is rotatable about an axis, such as a pulley, gear, sprocket or the like. It is a further object of the present invention to provide a torque sensing device having non-contacting magnetic field sensors positioned proximate to a plate-shaped member, for measuring the torque transmitted between a shaft and a radially separated portion of the plate-shaped-member. A further object of the invention is to provide a drive plate or the like including a central disc, made of magnetizable material, and an outer rim coupled to the central disc, whereby the central disc and the outer rim are assembled in a way to gain improved rotational signal uniformity (RSU) which itself preferably does not underlie any changes over lifetime. A further object of the invention relates to a torque sensing device which enables the arrangement of the device in a surrounding protected against external material such as dirt, dust, oil and the like.

It is another object of the invention to provide a torque sensing device having magnetic field sensors placed in pairs, with the magnetic field sensors having the sensing direction opposite one another to minimize the detrimental effects of magnetic noise, including compassing. According to another object of the invention to provide a torque sensing device which has an annular magnetoelastically conditioned region to enhance the rotational signal uniformity (RSU) performance of the torque sensing device.

It is a further object of the invention to minimize the costs of production and maintenance.

It is the intention of the invention to connect a central disc with an outer rim and/or to connect the central disc with a region of magnetizable material within the central disk without applying any press-fitting nor any shrink-fitting methods or devices. Thus avoiding the application of any stress neither to the central disc nor to the outer rim.

The central disc can also be referred to as disc, central magnetized disc or inner disc. In the following the wording central disc and disc will be used parallel.

According to invention the connection of the central disk with the outer rim and/or the connection of the central disc with a region of magnetizable material is performed by any means other than press-fitting or press-shrinking.

To permit a connection of the central disk to the outer rim and/or to permit the connection of the central disk to the region of magnetizable material to act as a mechanical unit, any fastening means can be applied such as pins, splines, keys, welds or adhesives. The welding process can be performed by any type of welding, e.g. laser welding, friction welding, electro welding and point welding. Other means of connection comprise riveting, welding, and the like except of press or shrink fits.

However, the connection of the central disk to the outer rim and/or the connection of the central disk to region of magnetizable material does not use any method or device based on press-fitting or shrink-fitting or the like.

It goes without saying that the connection is not limited to the means listed above. Any other technical means of forming and/or forging the central disc with the outer rim and/or forming and/or forging the central disc with a region of magnetizable material can be applied except of a means using a press-fitting-method, a shrink-fitting-method nor any device related to press-fitting nor shrink-fitting.

According to the invention the connection between the central disk and/or the region of magnetizable material and/or the outer rim is performed by any means or method other press-fitting or shrink-fitting. The connection of said parts does avoid any magneto-related stress to the central disk. Therefore, there is no stress level required to establish the connection.

When the assembly of the central disc and/or the region of magnetizable material and/or the outer rim is not accomplished by press-fitting, the process of press-fitting does not influence the magnetization condition of the combined parts. Also, the press-fitting does not lead to any stress of the magnetization and magnetic fields in respect of both of central disc and/or the region of magnetizable material and/or the outer rim. When a connection is not established by press-fitting nor by shrink-fitting tolerances of manufacturing do not need to be taken into account separately, even though press-fitting usually requires a considerable amount of force to fit the individual parts together.

A torque sensor is disclosed is U.S. Pat. No. 8,424,393.

### BRIEF DESCRIPTION OF DRAWINGS

FIG. 1 is a perspective view of a disc-shaped member according to the present invention.

FIG. 2 is a side elevation view of the disc-shaped member of FIG. 1, depicting the magnetization of a magnetoelastic active region, according to an embodiment of the present invention.

FIG. 3 is a top view of the disc-shaped member of FIG. 2, depicting the magnetization of a magnetoelastic active region, according to an embodiment of the present invention.

FIG. 4A is a graph illustrating the strengths of the magnetic fields in the magnetically conditioned regions when the torque sensing device of the present invention is in a quiescent state.

FIG. 4B is a top view of a disc-shaped member according to the present invention, illustrating the relationship between the disc-shaped member and the graph of FIG. 4A.

FIG. 5 is a top view of a disc-shaped member, showing illustrative positioning of magnetic field sensors, according to another embodiment of the present invention.

FIG. 6 is a top view of a disc-shaped member, showing illustrative positioning of magnetic field sensors, according to another embodiment of the present invention.

FIG. 7 is a top view of a disc-shaped member, showing illustrative positioning of magnetic field sensors, according to another embodiment of the present invention.

FIG. 8 is a top view of a disc-shaped member, showing illustrative positioning of magnetic field sensors, according to another embodiment of the present invention.

FIG. 9 is a top view of a disc-shaped member, showing illustrative positioning of magnetic field sensors, according to another embodiment of the present invention.

FIG. 10 is a perspective view of a disc-shaped member according to the present invention illustrating a change in the magnetization of the magnetoelastically active region when the disc-shaped member is subjected to torque,

FIG. 11 is a perspective view showing an exemplary torque sensing device provided with a component comprising a central disk and an outer rim according to the present invention for use in an automotive drive train,

FIG. 12 is an axial cut of the component 1350 shown in FIG. 11 and

FIG. 13 is an exploded view of a housing which includes the sensor module and/or other compositions typically found in magneto-elastic torque sensors such as a printed circuit board, a controller or a transceiver (not shown) for example.

### DETAILED DESCRIPTION

Several preferred embodiments of the invention are described for illustrative purposes, it being understood that the invention may be embodied in other forms not specifically shown in the drawings. The figures herein are provided for exemplary purposes and are not drawn to scale.

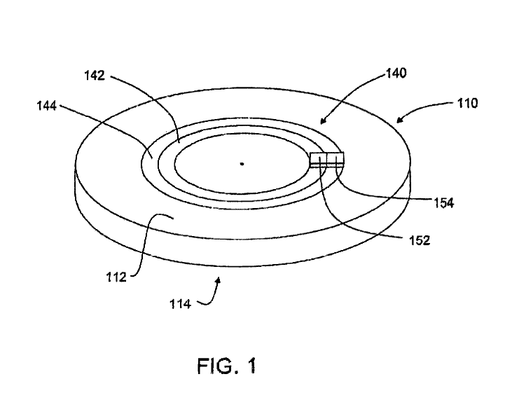

Turning first to FIG. 1, shown therein is a perspective drawing of a generally disc-shaped member 110 in accordance with the torque sensing device of the present invention. The disc 110 is formed of ferromagnetic material and is, or at least includes, a magnetoelastically active region 140. The material selected for forming the disc 110 must be at least ferromagnetic to ensure the existence of magnetic domains for at least forming a remanent magnetization in the magnetoelastically active region 140, and must be magnetostrictive such that the orientation of magnetic field lines in the magnetoelastically active region 140 may be altered by the stresses associated with applied torque. The disc 110 may be completely solid, or may be partially hollow. The disc 110 may be formed of a homogeneous material or may be formed of a mixture of materials. The disc 110 may be of any thickness, and is preferably between about 2 mm and about 1 cm thick.

The magnetoelastically active region 140 is preferably flat, and comprises at least two radially distinct, annular, oppositely polarized magnetically conditioned regions 142, 144, defining the magnetoelastically active region 140 of the torque sensing device. The top and bottom surfaces 112, 114 do not have to be flat, however, as shown, but could have variable thickness in cross-section from the center of the disc 110 to the outer edge. Depending on the application for which the torque sensing device is desired, it may be impractical to position magnetic field sensors 152, 154 on both sides of the disc 110. Therefore, the present invention is designed to function in instances where the magnetoelastically active region 140 is present on only one surface of the disc 110. However, the magnetoelastically active region 140 may be present on both sides of the disc 110.

The magnetoelastically active region 140 has a wall thickness such that the magnetization is detectable at both sides of the disc 110. The thickness of the magnetoelastically active region 140 can be chosen depending to the required intensity of magnetization. At least two, preferably four magnets are applied on the inner band and least two, preferably four magnets are applied on the outer band of the magnetoelastically active region 140. The magnets are arranged at preferably 45° apart from each other to achieve the best possible performance.

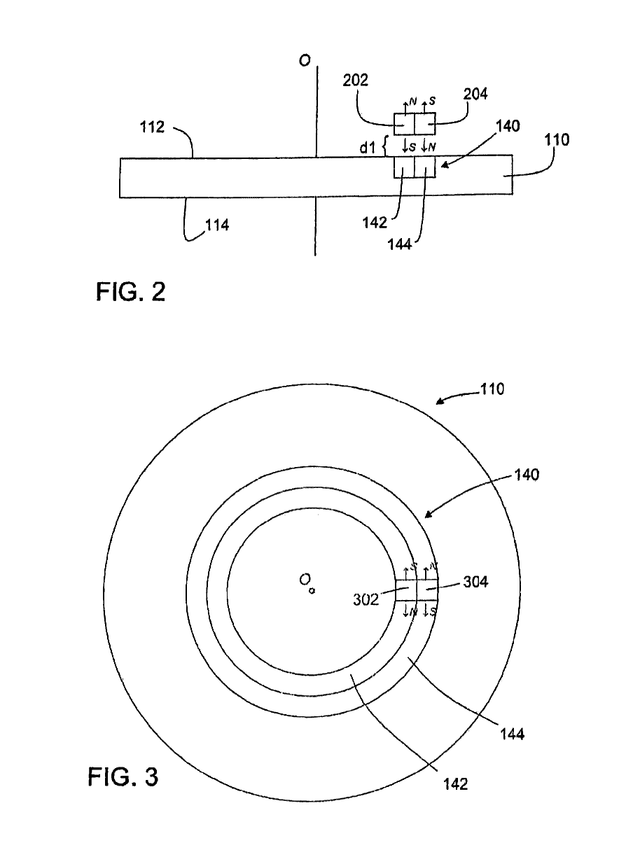

FIG. 2 shows a side view of the disc 110, and illustrates a process by which the magnetoelastically active region 140 may be formed on an annular portion of the disc 110. As shown, two permanent magnets 202, 204, having opposite directions of magnetization (and thus opposite polarity), are positioned proximate to the surface of the disc 110 at a distance d1. Following the positioning of the permanent magnets 202, 204, the disc 110 may be rotated about its central axis O, resulting in the formation of two annular, oppositely polarized, magnetically conditioned regions 142, 144. Alternatively, the magnetically conditioned regions 142, 144 may be formed by rotating the permanent magnets about the central axis O, while the disc 110 remains stationary. During creation of the magnetoelastically active region 140, the speed of rotation about the central axis O, and the distance d1 between the permanent magnets 202, 204 and the surface of the disc 110, should be kept constant to ensure uniformity of the magnetoelastically active region 140 and improve the RSU performance of the torque sensing device. Preferably, during the creation of the magnetoelastically active region 140, the permanent magnets 202, 204 are positioned adjacent to one another, with no gap there between, to form magnetically conditioned regions 142, 144 with no gap there between. The absence of a gap between the magnetically conditioned regions 142, 144 is understood to result in a torque sensing device with improved RSU performance.

In forming the magnetoelastically active region 140, the strength of the permanent magnets 202, 204, and the distance d1 between the permanent magnets 202, 204 and the disc 110, must be carefully selected to optimize performance of the torque sensing device. By using stronger permanent magnets 202, 204, and by positioning permanent magnets 202, 204 closer to the disc 110, one can generally produce a magnetoelastically active region 140 that will provide a stronger, more easily measurable signal, when employed by a torque sensing device. However, by using permanent magnets 202, 204 that are excessively strong, or by placing permanent magnets 202, 204 excessively close to the disc 110, one can produce a magnetoelastically active region 140 that exhibits hysteresis, which negatively affects the linearity of the signal produced by the torque sensing device in response to an applied torque. Preferably, the magnetoelastically conditioned region 140 is created using rectangular N42 or N45 grade neodymium iron boron (NdFeB) magnets placed at a distance of between about 0.1 mm and 5 mm from the surface of the disc 110. More preferably, magnets are placed at a distance of about 3 mm from the surface of the disc 110. Preferably, the width of the magnetoelastically active region 140 is not greater than 13 mm. More preferably, the width of the magnetoelastically active region 140 is about 10 mm.

FIG. 2 shows an embodiment having permanent magnets 202, 204 with directions of magnetization that are perpendicular to the plane of the disc 110. This configuration results in magnetically conditioned regions 142, 144 that are initially polarized in the axial direction (i.e., perpendicular to the disc surface). In this configuration, the magnetically conditioned regions 142, 144 are preferably polarized such that, in the absence of torque applied to the disc 110 (i.e., when the torque sensing device is in the quiescent state), the magnetically conditioned regions 142, 144 have no net magnetization components in the circumferential or radial directions.

During formation of the magnetoelastically active region 140, the permanent magnets 202, 204 may be positioned, as shown in FIG. 2, such that the innermost magnetically conditioned region 142 is created with its magnetic north pole directed upward, and the outermost magnetically conditioned region 144 is created with its magnetic north pole directed downward. Alternatively, during formation of the magnetoelastically active region 140, the permanent magnets may be positioned such that the innermost magnetically conditioned region 142 is created with its magnetic north pole directed downward, and the outermost magnetically conditioned region 144 is created with its magnetic north pole directed upward.

FIG. 3 shows a top view of the disc 110, and illustrates an embodiment in which the magnetoelastically active region 140 is created with permanent magnets 302, 304 having directions of magnetization that are parallel to the plane of the disc 110, in the circumferential direction. This configuration results in magnetically conditioned regions 142, 144 that are initially polarized in the circumferential direction of the disc 110. In this configuration, the magnetically conditioned regions 142, 144 are preferably polarized such that, in the absence of torque applied to the disc 110, the magnetically conditioned regions 142, 144 have no net magnetization components in the axial or radial directions.

During formation of the magnetoelastically active region 140, the permanent magnets 302, 304 may be positioned, as shown in FIG. 3, such that the innermost magnetically conditioned region 142 is created with its magnetic north pole having a clockwise orientation, and the outermost magnetically conditioned region 144 is created with its magnetic north pole having a counter-clockwise orientation. Alternatively, during formation of the magnetoelastically active region, the permanent magnets 302, 304 may be positioned such that the innermost magnetically conditioned region 142 is created with its magnetic north pole having a counter-clockwise orientation, and the outermost magnetically conditioned region 144 is created with its magnetic north pole having a clockwise orientation.

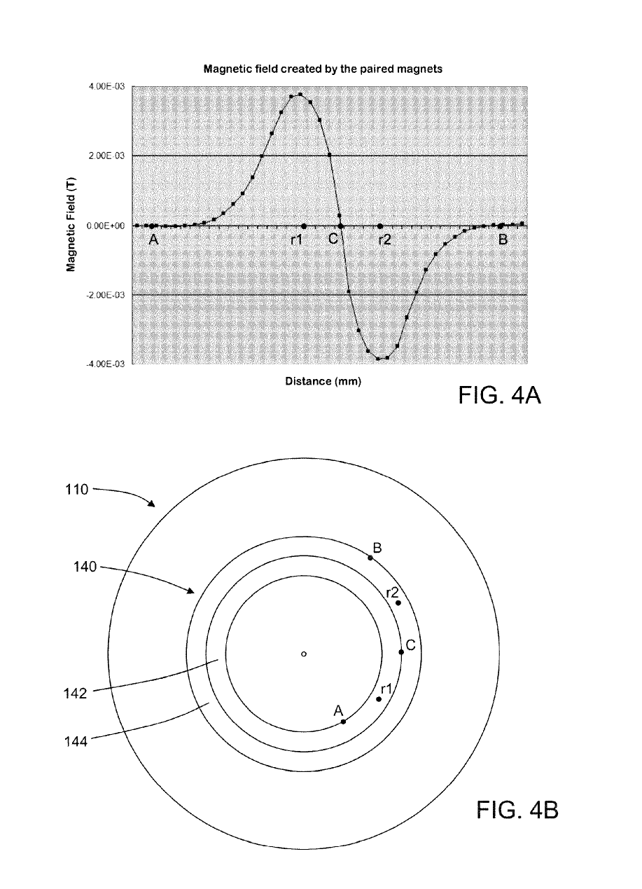

Turning to FIGS. 4A and 4B, FIG. 4A is a graph illustrating the strength of the magnetic fields in the magnetically conditioned regions 142, 144 when the torque sensing device is in the quiescent state. Values along the vertical axis represent the magnetic field strength of the magnetoelastically active region 140. The magnetic fields emanating from the surface of the disc 110 may have their principle components in the axial direction, as with the disc 110 of FIG. 2, or in the circumferential direction, as with the disc 110 of FIG. 3. Values along the horizontal axis represent distance along a radius of the disc 110 from the center line O to the outer edge of the disc 110. Point A corresponds to a point along the edge of the innermost magnetically conditioned region 142 nearest the center of the disc 110. Point B corresponds to a point along the edge of the outermost magnetically conditioned region 144 nearest the circumferential edge of the disc 110. Point C corresponds to a point along the boundary between the innermost and outermost magnetically conditioned regions 142, 144. Point r1 corresponds to a point within the innermost magnetically conditioned region 142, at which the magnetic field strength is at a maximum. Point r2 corresponds to a point within the outermost magnetically conditioned region 144, at which the magnetic field strength is at a maximum. FIG. 4B shows the disc 110 with points A, B, C, r1, and r2 corresponding to those points shown in the graph of FIG. 4A. Points r1 and r2, corresponding to the peak magnetic fields, indicate the distances from the center of the disc 110 at which magnetic field sensors 152, 154 should be placed to optimize the direction of the external magnetic flux, and hence maximize the performance of the torque sensing device. The units provided in FIG. 4 are for exemplary purposes and are not limiting on the present invention.

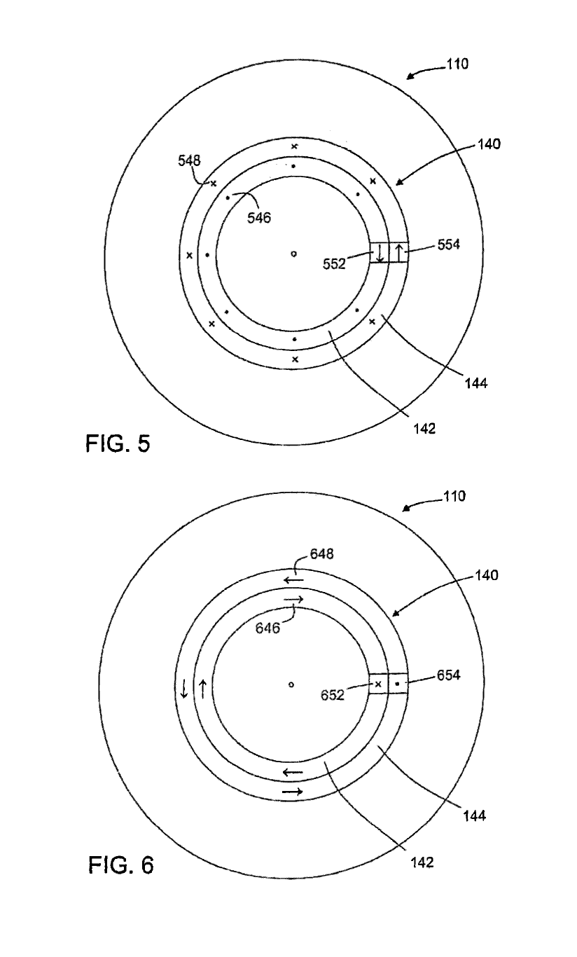

Turning to FIG. 5, shown therein is a top view of the disc 110 in the quiescent state, with a magnetoelastically active region 140 created by permanent magnets 202, 204 as shown in FIG. 2. The magnetoelastically active region 140 includes dual magnetically conditioned regions 142, 144 that are oppositely polarized in positive and negative axial directions, respectively. The dots in FIG. 5 indicate magnetic field lines 546 oriented perpendicular to the surface of the disc 110, such that the magnetic field lines 546 are directed out of the page. The X's in FIG. 5 indicate magnetic field lines 548 oriented perpendicular to the surface of the disc 110, such that the magnetic field lines 548 are directed into the page.

A pair of magnetic field sensors 552, 554 is positioned proximate to the magnetoelastically active region 140, such that each magnetic field sensor 552, 554 is placed over the portion of the magnetically conditioned region 142, 144 at a location where the magnetic field strength is at a maximum. The magnetic field sensors 552, 554 are oriented such that their sensitive directions are perpendicular to the direction of magnetization in the magnetoelastically active region 140. In FIG. 5, arrows indicate the sensitive directions of the magnetic field sensors 552, 554. Magnetic field sensors 552, 554 are oriented with their sensitive directions parallel to the surface of the disc 110 (i.e., in the circumferential direction), and the magnetically conditioned regions 142, 144 are polarized perpendicular to the surface of the disc 110 (i.e., in the axial direction). This configuration ensures that the representative signals outputted by the magnetic field sensors 552, 554 vary linearly with respect to variations in the torque applied to the disc 110.

Magnetic field sensors 552, 554 are oppositely polarized and provided in pairs. This placement technique may be referred to as a common mode rejection configuration. Output signals from each of the magnetic field sensors 552, 554 in the pair may be summed to provide a signal representative of the torque applied to the disc 110. External magnetic fields have equal effects on each of the magnetic field sensors 552, 554 in the pair. Because the magnetic field sensors 552, 554 in the pair are oppositely polarized, the summed output of the magnetic field sensors 552, 554 is zero with respect to external magnetic fields. However, because the magnetically conditioned regions 142, 144 are oppositely polarized, as are the magnetic field sensors 552, 554, the summed output of the magnetic field sensors 552, 554 is double that of each individual magnetic field sensor 552, 554 with respect to the torque applied to the disc 110. Therefore, placing magnetic field sensors 552, 554 in a common mode rejection configuration greatly reduces the detrimental effects of compassing in the torque sensing device.

Turning to the embodiment shown in FIG. 6, the disc 110 is shown in the quiescent state, and has a magnetoelastically active region 140 created by permanent magnets 302, 304 as shown in FIG. 3. The magnetoelastically active region 140 includes dual magnetically conditioned regions 142, 144 that are oppositely polarized, with magnetic field lines 646, 648, in opposite circumferential directions. A pair of magnetic field sensors 652, 654 may be positioned proximate to the magnetoelastically active region 140, such that each magnetic field sensor 652, 656 is placed over the portion of a magnetically conditioned region 142, 144 at a location where the magnetic field strength is at a maximum. The magnetic field sensors 652, 654 are oriented such that their sensitive directions are perpendicular to the direction of magnetization in the magnetoelastically active region 140. In FIG. 6, a dot (indicating a direction out of the page) and an X (indicating a direction into the page) indicate the sensitive directions of the magnetic field sensors 652, 654. Magnetic field sensors 652, 654 are oriented with their sensitive directions perpendicular to the surface of the disc 110 (i.e., in the axial direction), and magnetically conditioned regions 142, 144 are polarized parallel to the surface of the disc 110 (i.e., in the circumferential direction) to ensure that the representative signals outputted by the magnetic field sensors 652, 654 vary linearly with respect to variations in the torque applied to the disc 110. Magnetic field sensors 652, 654 are placed in a common mode rejection configuration to reduce the effects of compassing in the torque sensing device.

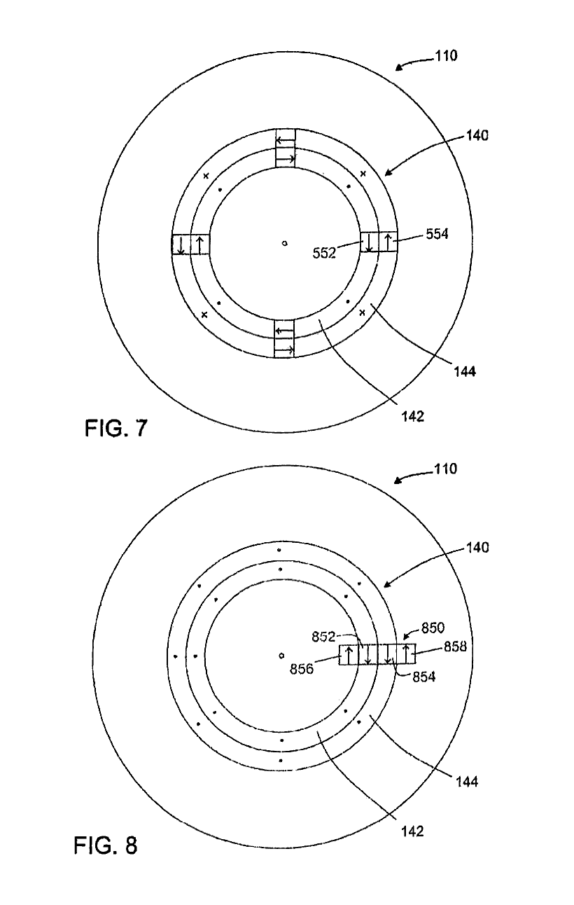

Turning to FIG. 7, shown therein is the disc 110 having a magnetoelastically active region 140 with dual magnetically conditioned regions 142, 144, which are polarized in opposite axial directions. Four pairs of magnetic field sensors 552, 554 are positioned proximate to the magnetoelastically active region 140 with their sensitive directions perpendicular to the magnetization of the magnetically conditioned regions 142, 144. The four pairs of magnetic field sensors 552, 554 are evenly spaced about the magnetoelastically active region 140 with approximately 90 degrees between each pair. This configuration provides for improved RSU performance because it allows for representative signals outputted by the multiple magnetic field sensors 552, 554 to be averaged, thereby resulting in a more accurate measurement of the torque applied to the disc 110. Any inaccuracies attributable to a single magnetic field sensor pair due to non-uniformities in the magnetoelastically active region 140 are of reduced significance when the representative signals from multiple magnetic field sensors 552, 554 are averaged. In torque sensing devices having magnetoelastically active regions 140 that exhibit a high degree of uniformity (i.e., RSU signal is substantially zero), as few as one pair of magnetic field sensors 552, 554 may be used to achieve sufficient RSU performance. However, due to limitations in material preparation and magnetization processes, a significant non-zero RSU signal may be difficult to avoid. In instances in which increased RSU performance is desired, the number of magnetic field sensor pairs may be increased. For example, eight pairs of magnetic field sensors 552, 554, spaced at 45 degrees, may be used.

Turning to FIG. 8, shown therein is the disc 110 having a magnetoelastically active region 140 with magnetically conditioned regions 142, 144 polarized in a single axial direction to form, essentially, a single magnetically conditioned region. A magnetic field sensor unit 850 includes four individual magnetic field sensors 852, 854, 856, 858. Primary magnetic field sensors 852, 854 are positioned proximate to the magnetoelastically active region 140, are aligned in the radial direction, and are similarly polarized in a direction perpendicular to the magnetization of the magnetoelastically active region 140. Secondary magnetic field sensors 856, 858 are positioned on opposite sides of the primary magnetic field sensors 852, 854, proximate to the disc 110, but apart from the magnetoelastically active region 140, such that the secondary magnetic field sensors 856, 858 do not pick up torque induced signals. The secondary magnetic field sensors 856, 858 are similarly polarized in a direction opposite that of the primary magnetic field sensors 852, 854. This configuration may be advantageous in instances in which a noise source (not shown) creates a local magnetic field gradient having different effects on each of the primary magnetic field sensors 852, 854, as discussed in U.S. Pat. App. Pub. No. 2009/0230953 to Lee, which is incorporated herein by reference. In such an instance, it may be assumed that the noise source has the greatest effect on the secondary magnetic field sensor 856, 858 closest to the noise source, and the least effect on the secondary magnetic field sensor 858, 856 farthest from the noise source. It may also be assumed that the effect of the noise source on the primary magnetic field sensors 852, 854 is between that of its effects on each of the secondary magnetic field sensors 856, 858. Finally, it may be assumed that the sum of the noise induced signals picked up by the secondary magnetic field sensors 856, 858 is equal in value to the sum of the noise induced signals picked up by the primary magnetic field sensors 852, 854. Therefore, by summing the signals picked up by each of the four magnetic field sensors 852, 854, 856, 858, the effect of magnetic noise on the magnetic field sensor unit 850 is canceled, and the composite signal picked up by the magnetic field sensor unit 850 is entirely torque induced.

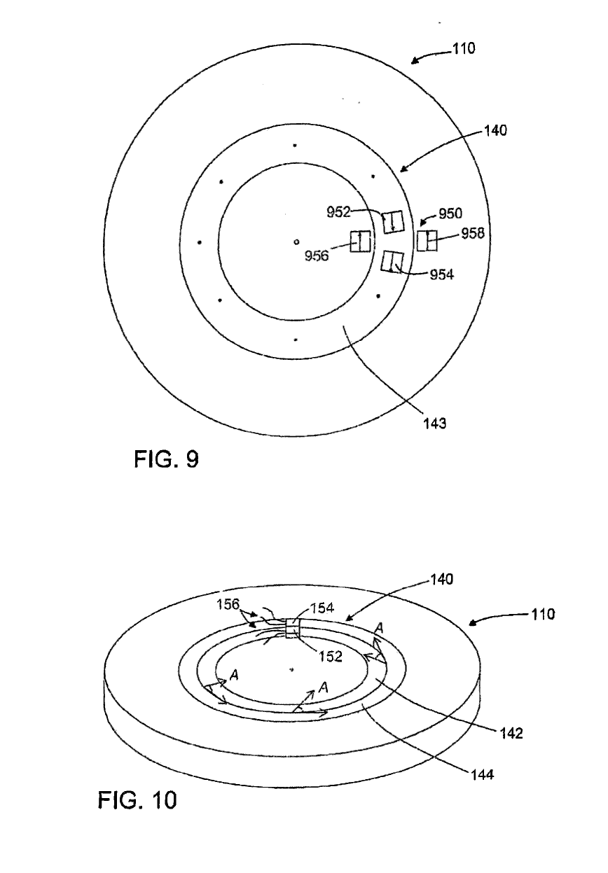

FIG. 9 shows a configuration of the disc 110 that may be advantageous in situations in which the radial space on the disc 110 is limited. The disc 110 has a magnetoelastically active region 140 with a single magnetically conditioned region 143 polarized in a single axial direction. A magnetic field sensor unit 950 includes four individual magnetic field sensors 952, 954, 956, 958. Primary magnetic field sensors 952, 954 are positioned proximate to the magnetoelastically active region 140, are aligned in the circumferential direction, and are similarly polarized in a direction perpendicular to the magnetization of the magnetoelastically active region 140. Secondary magnetic field sensors 956, 958 are positioned on opposite sides of the primary magnetic field sensors 952, 954, proximate to the disc 110, but apart from the magnetoelastically active region 140, such that the secondary magnetic field sensors 956, 958 do not pick up torque induced signals. The secondary magnetic field sensors 956, 958 are similarly polarized in a direction opposite that of the primary magnetic field sensors 952, 954. This configuration may be advantageous in instances in which a noise source (not shown) creates a local magnetic field gradient having different effects on each of the primary magnetic field sensors 952, 954, as discussed in U.S. Pat. App. Pub. No. 2009/0230953 to Lee, which is incorporated herein by reference. In such an instance, it may be assumed that the noise source has the greatest effect on the secondary magnetic field sensor 956, 958 closest to the noise source, and the least effect on the secondary magnetic field sensor 958, 956 farthest from the noise source. It may also be assumed that the effect of the noise source on the primary magnetic field sensors 952, 954 is between that of its effects on each of the secondary magnetic field sensors 956, 958. Finally, it may be assumed that the sum of the noise induced signals picked up by the secondary magnetic field sensors 956, 958 is equal in value to the sum of the noise induced signals picked up by the primary magnetic field sensors 952, 954. Therefore, by summing the signals picked up by each of the four magnetic field sensors 952, 954, 956, 958, the effect of magnetic noise on the magnetic field sensor unit 950 is canceled, and the composite signal picked up by the magnetic field sensor unit 950 is entirely torque induced.

FIG. 10 provides an illustration of the principle by which torque applied to the disc 110 is measured by the torque sensing device. As discussed above, in the quiescent state, the magnetic fields in the magnetoelastically active region 140 are aligned either substantially exclusively in the axial direction, as shown in FIG. 5, or substantially exclusively in the circumferential direction, as shown in FIG. 6. When torque is applied to the disc 110, magnetic moments in the magnetoelastically active region 140 tend to tilt along the shear stress direction, which forms an angle of about 45 degrees with respect to the surface of the disc 110, as indicated by arrows A in FIG. 10. This tilt causes the magnetization of the magnetoelastically active region 140 to exhibit a decreased component in the initial direction, and an increased component in the shear stress direction. The degree of tilt is proportional to the strength of the torque applied to the disc 110. The magnetic field sensors 152, 154 are capable of sensing changes in the strength of magnetic field components along the sensitive directions of the magnetic field sensors 152, 154. Therefore, when torque is applied to the disc 110, magnetic field sensors 152, 154 output representative signals that are proportional to the applied torque.

Magnetic field sensors 152, 154 are known in the art and include magnetic field vector sensor devices such as flux-gate inductors, Hall Effect sensors, and the like. Preferably, the magnetic field sensors according to the present invention are flux-gate inductors having a solenoid form. In another embodiment, the magnetic field sensors 152, 154 may be integrated circuit Hall Effect sensors. Conductors 156, as shown in FIG. 10, connect the magnetic field sensors to a source of direct current power, and transmit the signal output of the magnetic field sensors 152, 154 to a receiving device (not shown), such as a control or monitoring circuit.

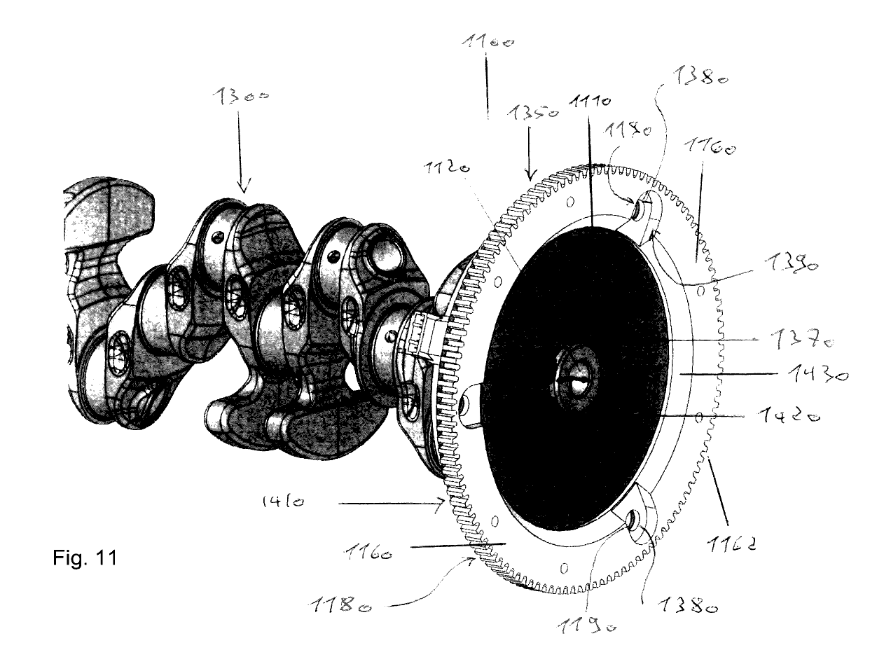

Turning to FIG. 11, shown therein is a perspective, exploded view drawing of a torque transducer 1100 in accordance with the present invention. In the exemplary embodiment shown, the torque transducer 1100 includes a central disc 1110, a hub 1120, and a shaft 1130 (not shown). The central disc 1110, the hub 1120, and the shaft 1130 may be, but are not necessarily, distinct elements. The central disc 1110 may be an axially thin, generally disc-shaped member, which may be completely flat or may include contours. The hub 1120 functions by rigidly attaching the central disc 1110 to the shaft 1130.

Attachment may be accomplished, for example, directly or indirectly by any known means which permits the hub 1120 and the shaft 1130 to act as a mechanical unit such that torque applied to the shaft 1130 is proportionally transmitted to the hub 1120 and vice versa.

Examples of means of attachment include pins, spline, keys, welds, adhesives and the like, except of press or shrink fits methods or devices.

Preferably, holes 1380 are provided in the central disc 1110 and the hub 1120 such that holes in the central disc 1110 correspond to holes in the hub 1120. Fasteners (not shown), such as bolts, may be inserted through holes 1380 in the central disc 1110 and corresponding holes 1190 in the hub 1120 such that a firm attachment is formed between the central disc 1110 and the hub 1120.

Examples of alternative means of attachment include riveting, welding, and the like except of press or shrink fits.

The central disc 1110 may be attached to an outer rim 1160, such that a portion of the central disc 1110 attached to the outer rim 1160 is radially distinct from a portion of the central disc 1110 attached to the hub 1120. The outer rim 1160 may surround the periphery of the central disc 1110, or may be attached to a surface of the central disc 1110. The outer rim 1160 may be an integral part of the central disc 1110. The central disc 1110 and the outer rim 1160 act as a mechanical unit such that torque applied to the central disc 1110 may be proportionally transmitted to the outer rim 1160, and vice versa. The outer rim 1160 may include force transfer features 1162 for the transfer of predominately tangential forces to a driving or driven member.

An exemplary embodiment of the invention is a torque sensing device for use in connection with an automobile engine wherein the central disc 1110 includes a drive plate, the shaft 1130 includes a crankshaft and the outer rim 1160 includes a torque converter. It will be apparent to those skilled in the art to which the invention pertains, however that the invention is not limited to any specific type of automobile configuration, nor is the invention limited to automotive applications in general.

The outer rim 1160 and the hub 1120 are preferably formed of non-ferromagnetic materials or are magnetically isolated from the central disc 1110 by non-ferromagnetic spacers, such as low permeability rings (not shown) inserted between the hub 1120 and the central disc 1110, and between the central disc 1110 and the outer rim 1160.

FIG. 11 shows a part of a drive train 1300 to which a component 1350 is fixed comprising the central disk 1110 and the outer rim 1160.

The component 1350 is fixed to the drive train 1300 by means of screws 1370. The screws 1370 are arranged around the hub 1120.

Looking into the direction of the screws 1370 shown in FIG. 11 the outer rim 1160 is fixed to the central disk 1110, with the back 1410 of the outer rim 1160 adjacent to the front 1420 of the central disc 1110.

There is a plurality of holes 1380 provided in the outer rim 1160 of the component 1350 to align with holes 1190 arranged in the outer part 1180 of the central disc 1110.

The outer rim 1160 is fastened to the central disk 1110 by means of fastening elements (not shown).

The fastening element can be any means such as a screw, a pin, a spline, a bolt with or without a thread, or the like. The fastening elements can be any technical body or method except of a press or shrink fit method or device.

In FIG. 11 the holes 1380 of the outer rim 1160 are arranged in recesses 1390.

The component 1350, comprising the central disk 1110 and the outer rim 1160 can be pre-assembled to be fixed to a drive train 1300 by means of the screws 1370 at a later stage.

The central disk 1110 comprises a region of magnetizable material 1400. The magnetoelastically active region 1400 must possess sufficient anisotropy to return the magnetization to the quiescent, or initial direction when the applied torque is reduced to zero. Magnetic anisotropy may be induced by physical working of the material of the central disc 1110 or by other methods. Illustrative methods for inducing magnetic anisotropy are disclosed in U.S. Pat. No. 5,520,059, incorporated herein by reference.

Preferably, the central disc 1110 is formed from X46Cr13 material. Examples of alternative materials from which the central disc 1110 may be formed are described in U.S. Pat. No. 5,520,059 and U.S. Pat. No. 6,513,395, incorporated herein by reference. The central disc 1110 may be formed of a material having a particularly desirable crystalline structure.

In another embodiment of the present invention, the magnetoelastically active region 1400 may be formed separately from the central disc 1110, and then applied to the central disc 1110 by means such as adhesives, welds, fasteners, or the like, except of press fit or shrink fit means such that torque induced in the central disc 1110 is transmitted in proportion to torque induced in the magnetoelastically active region 1400. The application of the active region 1400 to the central disc 1110 can be achieved in any way or method except of press fitting or shrink fitting.

In the operation of the present invention, magnetic fields arise from the magnetoelastically active region 1400 and these fields pervade not only the space in which the magnetic field sensors 1152, 1154 (not shown) are located but also the space occupied by the central disc 1110 itself. Magnetization changes that take place within non-active portions of the central disc 1110 may result in the formation of parasitic magnetic fields that may pervade the regions of space where the magnetic field sensors 1152, 1154 (not shown) are located. The hub 1120 and the outer rim 1160 can be formed of non-ferromagnetic materials to reduce or eliminate parasitic magnetic fields. Thus, in the interest of not corrupting the transfer function of the magnetoelastically active region 1400, it is important that the parasitic fields be very small, ideally zero, in comparison with the magnetic field arising from the magnetoelastically active region 1400 or, if of significant intensity, that they change linearly and anhysteretically (or not at all) with applied torque, and that they be stable with time and under any of the operational and environmental conditions that the shaft 1130 (not shown), the central disc 1110, and the magnetoelastically active region 1400 might be subjected to. Stated otherwise, any parasitic fields which arise must be sufficiently small compared to the magnetoelastically active region field 1400 such that the net field seen by the magnetic field sensors 1152, 1154 (not shown) is useful for torque sensing purposes. Thus, in order to minimize the corrupting influence of parasitic fields, it is important to utilize a central disc material having a coercivity sufficiently high that the field arising from the magnetoelastically active region 1400 does not magnetize regions of the central disc 1110 proximate to the magnetoelastically active region 1400 to give rise to such parasitic magnetic fields which are of sufficient strength to destroy the usefulness, for torque sensing purposes, of the net magnetic field seen by the magnetic field sensors 1152, 1154 (not shown). This may be accomplished, for example, by using a material in which the coercivity of the central disc 1110 is greater than 15 Oe, preferably greater than 20 Oe, and most desirably greater than 35 Oe.

In addition to torque, the present invention is capable of measuring power, energy, or rotational speed, wherein

Power=Torque×2n×Rotational Speed, and

Energy=Power/Time.

In FIG. 11 an embodiment is shown in which the outer rim 1160 can be an integral part of the central disc 1110 comprising a region of magnetizable material 1400. The outer rim 1160 is coupled to the region of magnetizable material 1400 whereby the coupling and assembling does not contribute to a magnet related stress within the system, especially within a drive plate or the like.

This is being achieved by avoiding that the drive train 1300 or the like is assembled by means of a mutual press-fitting-process between the central disk 1110 and the outer rim 1160.

In FIG. 11 the region of magnetizable material 1400 is of a circular form. It can be arranged so that the region 1400 surrounds the hub 1120.

The region of magnetizable material 1400 comprises first and second concentric magnetized portions (not shown) whereby a magnetic flux may be configured to work clockwise in a first concentric magnetized portion 1400 and also work counter-clockwise in a second concentric magnetized portion, vice versa (also not shown).

In a further embodiment the central disc 1110 comprising the region of magnetizable material 1400 may be considerable thinner than the outer rim 1160 thus facilitating the manufacturing process.

Also it encourages different materials to be used for manufacturing both the central disk 1110 and the outer rim 1160.

Instead of providing holes 1380 in the outer rim 1160 and/or instead of providing holes 1190 in the outer part 1180 of the central disc 1110, the central disc 1110 and the outer rim 1160 can be welded together. The welding process can be performed by any type of welding, e.g. laser welding, friction welding, electro welding and point welding. It goes without saying that the central disc 1110 and the outer rim 1160 can alternatively be connected to each other by means of riveting and/or glueing. Said means of riveting and/or glueing do not include means that involve any press-fitting or shrink fitting.

It is the intension of the invention to connect the central disc 1110 with the outer rim 1160 or to connect the central disc 1110 with the region of magnetizable material 1400 without applying any press-fitting nor any shrink-fitting methods or devices. Thus avoiding the application of any stress neither to the central disc 1110 nor to the outer rim 1160.

In a preferred embodiment the inner disc 1110 comprising the magnetized portion maybe considerably thinner than the outer rim 1160. This enables an easier manufacturing process. It also allows a different material compared to outer rim 1160 depending on the field of use. It can be seen in FIG. 11 that a plurality of holes 1190 are arranged at the outer part 1180 of the inner disc 1110. This outer part 1180 of the central disc 1110 is the basis for its connecting with outer rim 1160. This can be done by using screws (not shown) which reach through holes 1190 to ensure the connection to outer rim 1160.

Instead of a connection by screws and holes 1190 the outer part 1180 of central disc 1110 could be also the basis for connecting the central disc 1110 to the outer rim 1160 by laser welding. It can be used any type of welding, e.g. laser welding, friction welding, electro welding and point welding.

Instead or additionally the connection can also be done with riveting the two pieces together.

Alternatively, the connection can also be done by gluing.

In general, it is preferable to use a connection of both of the parts which avoid any stress to the central disc 1110.

Any type of forming and/or forging two pieces together are appropriate except the press-fitting.

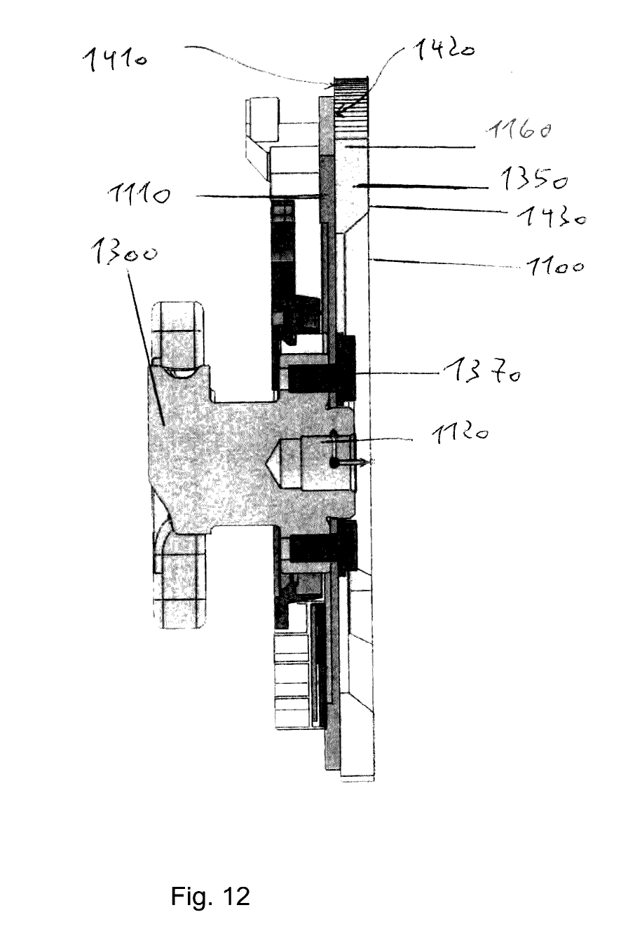

FIG. 12 is an axial cut of the component 1350 shown in FIG. 11 comprising the drive train 1300, the central disc 1110 and the outer rim 1160.

The back 1410 of the outer rim 1160 is arranged alongside the front 1420 of the central disc 1110.

The component 1350 comprising the central disc 1110 and the outer rim 1160 are held fixedly coupled together by means of fastening elements (not shown). The component 1350 is fixed to the drive train 1300 by means of screws 1370.

In FIG. 12 the screws 1370 are arranged circularly around the hub 1120 of the drive train 1300.

A casing 1430 is arranged to house at least one of the central disc 1110 and/or the outer rim 1160 and/or the transducer 1100. The casing 1430 is sealed to protect the central disc 1110 and/or the outer rim 1160 and/or the transducer 1100 against damage and/or any external contamination.

The casing 1430 can be manufactured from any non-magnetic material.

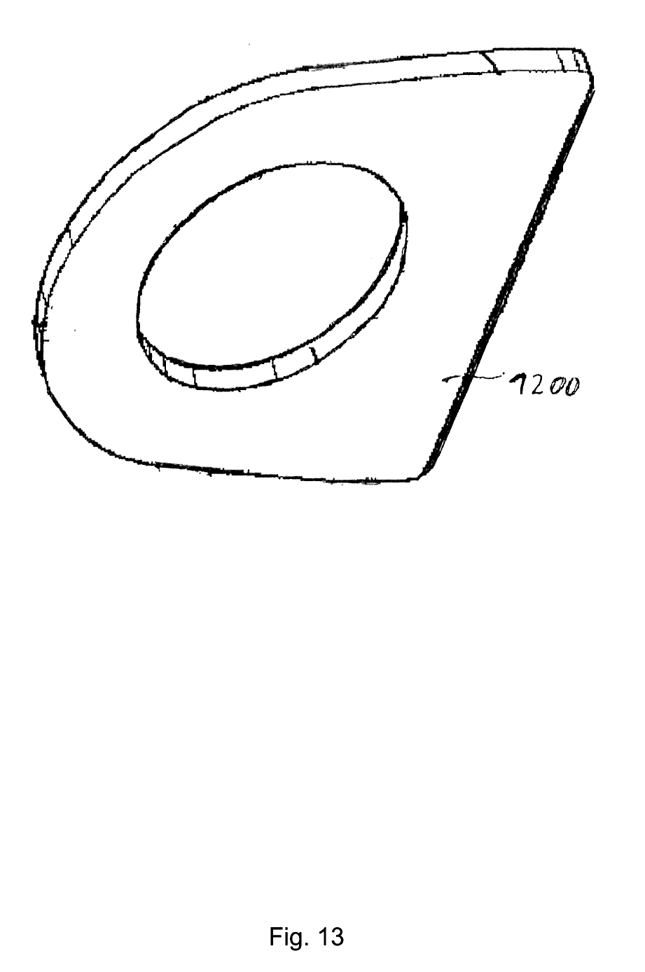

In FIG. 13 the above-mentioned drive plate or the like is in its function interrelated to the torque sensor which includes at least one magnetic flux sensing element 1210, e.g. a fluxgate (not shown). This sensor module (not shown) is implemented in a housing 1200.

The housing 1200 contains the at least one magnetic flux sensing element which may be molded or in any another form embedded in the housing 1200. The housing 1200 also has a sealing function to seal and protect the sensor module against outer external material such as dirt, dust, oil and the like. This prolongs the lifespan of the magnetic flux sensing element. The sensor module being preferably fixedly embedded in the sealing housing 1200 allows an exact position adjacent to magnetized portion 1400 in order to enable the sensing elements to sense a torque-induced magnetic field. Preferably there is a small distance between sensor module embedded in housing 1200 and magnetized portion 1400. Hereby in case of a configuration of a drive plate the drive plate can rotate easily relative to the torque sensor.

In this configuration of FIG. 13 it is the advantage that in case of use of the invention in the field of automotive transmissions the two separate components for the engine seal and the sensor are fully integrated into the engine seal to avoid extra components.

Although certain presently preferred embodiments of the disclosed invention have been specifically described herein, it will be apparent to those skilled in the art to which the invention pertains that variations and modifications of the various embodiments shown and described herein may be made without departing from the spirit and scope of the invention.

1. A torque sensor assembly for an engine comprising:
a transducer (1100) including:
a central disc (1110); and
an outer rim (1160) coupled to the central disc (1110); and
at least one sensing element (1210) spaced from the transducer (1100) and configured to determine an amount of torque exerted on the central disc (1110) by sensing a magnetic flux passing through the central disc (1110), and a housing (1200) comprising the sensing element (1210) and whereby the central disc (1110) and the outer rim (1160) are assembled in a way that stress to the central disc (1110) is avoided.

2. The torque sensor assembly of claim 1, wherein the central disc (1110) and the outer rim (1160) is assembled by at least one of welding, screwing, riveting, gluing, and arranging in a casing (1430).

3. The torque sensor assembly of claim 1, wherein the housing (1200) is a sealing element.

4. The torque sensor assembly of claim 1, wherein the central disc (1110) includes a first magnetizable material that is magnetized and the outer rim (1160) includes a second material that is different from the first material.

5. The torque sensor assembly of claim 4 wherein the central disc (1110) is thinner than the outer rim (1160).

6. The torque sensor assembly of claim 1, wherein the sensing element (1210) is a magneto-elastic torque sensor.

7. The torque sensor assembly of claim 6, wherein the magnetic torque sensor includes magnetic flux sensing elements.

8. The torque sensor assembly of claim 1, wherein the magnetic torque sensor is configured to determine the amount of torque exerted on the central disc (1110) by measuring, via the magnetic flux sensing elements, the magnetic flux emitting from the central disc (1110).

9. An engine including a drive train (1300) having a power source, the motor vehicle comprising:
a transducer (1100) including:
a central disc (1110); and
an outer rim (1160) coupled to the central disc (1110); and
at least one sensing element (1210) spaced from the transducer (1100) and configured to determine an amount of torque exerted on the central disc (1110) by sensing a magnetic flux emitting from the central disc (1110), and a housing (1200) comprising the sensing element (1210) and whereby the central disc (1110) and the outer rim (1160) is assembled in a way that magneto-related stress to the central disc (1110) is avoided.

10. The drive train (1300) of claim 9, wherein the central disc (1110) and the outer rim (1160) is assembled by at least one of welding, screwing, riveting, and gluing.

11. The drive train (1300) of claim 9, wherein the central disc (1110) includes a first magnetizable material that is magnetized and the outer rim (1160) includes a second material that is different from the first material.

12. The drive train (1300) of claim 11, wherein the central disc (1110) of the transducer (1100) is thinner than the outer rim (1160).

13. The drive train (1300) of claim 9, wherein the magnetic torque sensor is a magneto-elastic torque sensor.

14. The drive train (1300) of claim 9, wherein the magnetic torque sensor includes magnetic flux sensing elements (1210).

15. The drive train (1300) of claim 14, wherein the magnetic flux sensing elements (1210) are fluxgate sensors.

16. The drive train (1300) of claim 14, wherein the magnetic torque sensor is configured to determine the amount of torque exerted on the central disc (1110) by measuring, via the sensing elements (1210), the magnetic flux extending from the central disc (1110).

17. The drive train (1300) of claim 14, further comprising a power source, the power source including an oil seal housing coupled thereto, and wherein the sensor is coupled to the oil seal housing.

18. The drive train (1300) of claim 9, wherein the housing (1200) is a sealing element.

19. A method for measuring torque in a drive train (1300) of an engine, the drive train (1300) including the transducer (1100) and a sensor, the method comprising: measuring, with the sensor, a magnetic flux passing through the transducer (1100).

20. The method of claim 19, further comprising: coupling a central magnetized disc (1110) to an outer rim (1160) to form the transducer (1100), and wherein measuring a magnetic flux includes measuring the magnetic flux passing through the central magnetized disc (1110).

21. The method of claim 20, further comprising: coupling an oil seal housing to a power source; and coupling the sensor to the oil seal housing.
